(19) United States
(12) Patent Application Publication
(10) Pub. No.: US 2005/0214721 A1
(43) Pub. Date: Sep. 29, 2005

(54) Scientific phenomena evaluation apparatus, educational tool for scientific experiments and manufacturing method of the device and tool

(75) Inventors: Yasunori Ichikawa, Minami-Ashigara-shi (JP); Tomohide Ueyama, Minami-Ashigara-shi (JP); Fumiko Shiraishi, Minami-Ashigara-shi (JP); Akira Kato, Minami-Ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/060,586

(22) Filed: Feb. 18, 2005

(30) Foreign Application Priority Data
Feb. 20, 2004 (JP) 2004-45318

(51) Int. Cl. G05D 7/00

(52) U.S. Cl. 434/126

(57) ABSTRACT

According to the invention, the plurality of long grooves each having a cross-sectional area of not more than 1 mm² are formed, an end of each of the plurality of flow passages joins in at one meeting point and furthermore, a liquid delivering device is provided. Therefore, it is possible to qualitatively observe scientific phenomena, such as the dispersion phenomena of molecules. Also, accuracies sufficient for experiencing high technologies, for example, various phenomena such as the diffusion phenomenon of a liquid, heat transfer phenomenon of a liquid, mixing phenomenon of liquids and chemical reactions of a liquid that occur in this fine flow passage are obtained, consumption of chemical agents and the like is small and environmental burdens are small. Therefore, the scientific phenomena evaluation apparatus is appropriate as an educational tool for scientific experiments.

### BACKGROUND OF THE INVENTION

1. Field of the Invention

The present invention relates to a scientific phenomena evaluation apparatus, an educational tool for scientific experiments and a manufacturing method of the evaluation apparatus and educational tool and, more particularly, to a scientific phenomena evaluation apparatus and an educational tool for scientific experiments that are inexpensive, cause only small environmental burdens and are suitable for enjoying high technologies quite easily and a manufacturing method the evaluation apparatus and educational tool.

2. Description of the Related Art

For scientific phenomena evaluation apparatus and educational tools for scientific experiments, those having various constructions have hitherto been proposed (refer to the Japanese Patent Application Laid-open No. 2000-242162).

For example in the Japanese Patent Application Laid-open No. 2000-242162, there is disclosed an educational tool of science that enables natural phenomena by changes in water temperature to be observed by causing the steam in the air or the water or steam contained in a container to be cooled or frozen, and this educational tool of science is small in size and simple in construction and is said to be able to faithfully reproduce various kinds of natural phenomena by changes in water temperature.

For chemical experiment apparatus for educational purposes, experimental kits such as “Science and Learning—Experimental Kit Series”, “Science for Grownups—Analysis Kits for the Global Environment”, and the like have been placed on the market. These experimental kits are on sale with relatively low prices of several hundreds to three thousand yen or so. They are experimental kits that give dreams to children and the pleasure of experiments to users and are enjoying great popularity.

### SUMMARY OF THE INVENTION

However, conventional scientific phenomena evaluation apparatus of this kind as described in the Japanese Patent Application Laid-open No. 2000-242162are relatively complicated in construction, and it is difficult to supply them at low prices. Therefore, they are not suitable for the purchase by all students of a class.

On the other hand, experimental kits having relatively simple construction are mostly relatively low priced and suitable for the purchase and use by all students of a class. However, many of such experimental kits are insufficient in terms of finishing accuracy and the consumption of chemical agents and the like is large. Therefore, when all students of a class use such experimental kits, this causes environmental burdens in terms of waste liquid treatment, for example, and this is undesirable.

Furthermore, the contents of experiments capable of being experienced with conventional experimental kits are classical scientific experiment methods, and it is only with very limited conventional experimental kits that students can enjoy high technologies quite easily.

The present invention has been made in view of the above circumstances and has as its object the provision of a scientific phenomena evaluation apparatus and an educational tool for scientific experiments that are inexpensive, cause only small environmental burdens and are suitable for enjoying high technologies quite easily, and a manufacturing method the evaluation apparatus and educational tool.

To achieve the above object, the present invention provides a scientific phenomena evaluation apparatus, comprising: a base plate on a plate-like surface of which there are formed a plurality of long grooves each having a cross-sectional area of not more than 1 mm²; and a cover plate that is disposed on a surface of the base plate in close contact therewith and forms a plurality of fine flow passages on the base plate by covering the long grooves, wherein an end of each of the plurality of flow passages joins in at one meeting point, the other end of each of the plurality of flow passages is in communication with a liquid reservoir each having a volume of 5 to 5000 mm³, a liquid delivering device is provided in one or more of the liquid reservoirs, and scientific phenomena in the flow passages can be visually recognized.

According to the invention, the plurality of long grooves each having a cross-sectional area of not more than 1 mm²are formed, an end of each of the plurality of flow passages joins in at one meeting point and furthermore, a liquid delivering device is provided. Therefore, it is possible to qualitatively observe scientific phenomena, such as the dispersion phenomena of molecules. Also, accuracies sufficient for experiencing high technologies, for example, various phenomena such as the diffusion phenomenon of a liquid, heat transfer phenomenon of a liquid, mixing phenomenon of liquids and chemical reactions of a liquid (for example, an acid-alkali reaction, a hydrolysis reaction) that occur in this fine flow passage are obtained, consumption of chemical agents and the like is small and environmental burdens are small. Therefore, the scientific phenomena evaluation apparatus is appropriate as an educational tool for scientific experiments.

Incidentally, the cross-sectional area of the fine flow passage is preferably not more than 1 mm², more preferably 0.0025 to 0.64 mm², and most preferably 0.01 to 0.25 mm².

A “liquid reservoir” is usually hollow and chemical agents and the like are supplied to this part when the evaluation apparatus is operated.

To achieve the above object, the invention also provides a scientific phenomena evaluation apparatus, comprising: a base plate on a plate-like. surface of which there are formed a plurality of long grooves each having a cross-sectional area of not more than 1 mm²; and a cover plate that is disposed on a surface of the base plate in close contact therewith and forms a plurality of fine flow passages on the base plate by covering the long grooves, wherein an end of a first flow passage and an end of a second flow passage meet each other at one meeting point, the two flow passages being the above-described flow passages having almost the same length, the other end of the first flow passage is in communication with a first liquid reservoir having a volume of 5 to 5000 mm³, the other end of the second flow passage is in communication with a second liquid reservoir having a volume of 5 to 5000 mm³, an end of a third flow passage, which is one flow passage as described above, is in communication with the meeting point, the other end of the third flow passage being in communication with a third reservoir having a volume of 5 to 5000 mm³, a liquid delivering device is provided in one or more of the liquid reservoirs, and scientific phenomena in the flow passages can be visually recognized.

According to the invention, in the evaluation apparatus there are formed three fine flow passages each having a cross-sectional area of 1 mm², an end of each of the flow passages join in at one meeting point, and furthermore a liquid delivering device is provided. Therefore, it is possible to qualitatively observe scientific phenomena, such as the dispersion phenomena of molecules. Also, accuracies sufficient for experiencing high technologies are obtained, consumption of chemical agents and the like is small and environmental burdens are small. Therefore, the scientific phenomena evaluation apparatus is appropriate as an educational tool for scientific experiments.

In the invention, it is preferred that the base plate and/or the cover plate be transparent. Also, in the invention, it is preferred that the base plate and/or the cover plate be formed from a resin material. When the base plate and/or the cover plate is transparent, scientific phenomena in the flow passage can be visually recognized. When the base plate and/or the cover plate is formed from a resin material, the evaluation apparatus can be supplied at low cost.

Also, in the invention, it is preferred that the liquid delivering device be a device that pressurizes the interior of the first liquid reservoir and the second liquid reservoir. By pressurizing the interior of the first liquid reservoir and the second liquid reservoir in this manner, various kinds of experiments can be easily performed.

To achieve the above object, the invention provides a manufacturing method of the scientific phenomena evaluation apparatus, comprising the steps of: applying a resin material to a surface of a reverse template on the surface of which a reverse shape of the long groove of the base plate is formed; causing the resin material to cure; and stripping the resin material after curing from the reverse template thereby to form the base plate.

To achieve the above object, the invention also provides a manufacturing method of the educational tool for scientific experiments, comprising the steps of: applying a resin material to a surface of a reverse template on the surface of which a reverse shape of the long groove of the base plate is formed; causing the resin material to cure; and stripping the resin material after curing from the reverse template thereby to form the base plate.

According to the invention, because the base plate is formed by printing by use of a reverse template on the surface of which a reverse shape of the long groove is formed, it is possible to supply the base plate with good accuracy and at low cost and to make the evaluation apparatus at low cost. Regardless of the expression “applying a resin material to a surface of a reverse template . . . ; causing the resin material to cure”, a method that involves applying a resin material to the surface of the reverse template and forming the shape of the long groove by printing by use a hot press is also based on the same technical philosophy. It can be said that such a method is within the scope of the present invention.

Incidentally, scientific phenomena are various chemical phenomena, physical phenomena and the like of a liquid that occur in the above-described fine flow passage and include the diffusion phenomenon of a liquid, heat transfer phenomenon of a liquid, mixing phenomenon of liquids and chemical reactions of a liquid (for example, an acid-alkali reaction, a hydrolysis reaction).

As described above, according to the invention, in the evaluation apparatus there are formed the plurality of fine flow passages each having a cross-sectional area of 1 mm², an end of each of the flow passages join in at one meeting point, and furthermore a liquid delivering device is provided. Therefore, it is possible to qualitatively observe scientific phenomena, such as the dispersion phenomena of molecules. Also, accuracies sufficient for experiencing high technologies are obtained, consumption of chemical agents and the like is small and environmental burdens are small.

### BRIEF DESCRIPTION OF THE DRAWINGS

FIG. 1 is a plan view to explain the construction of a scientific phenomena evaluation apparatus of the invention;

FIG. 2 is a partially enlarged view of FIG. 1;

FIG. 3 is a partially enlarged sectional view of FIG. 1;

FIGS. 4A to 4D are each a sectional view that shows the procedure of an experiment;

FIGS. 5A and 5B are each a sectional view that shows the procedure of an experiment;

FIG. 6 is a plan view that shows the construction of a liquid delivering device; and

FIG. 7 is a plan view that shows the construction of the second embodiment of the present invention.

### DETAILED DESCRIPTION OF THE PREFERRED EMBODIMENTS

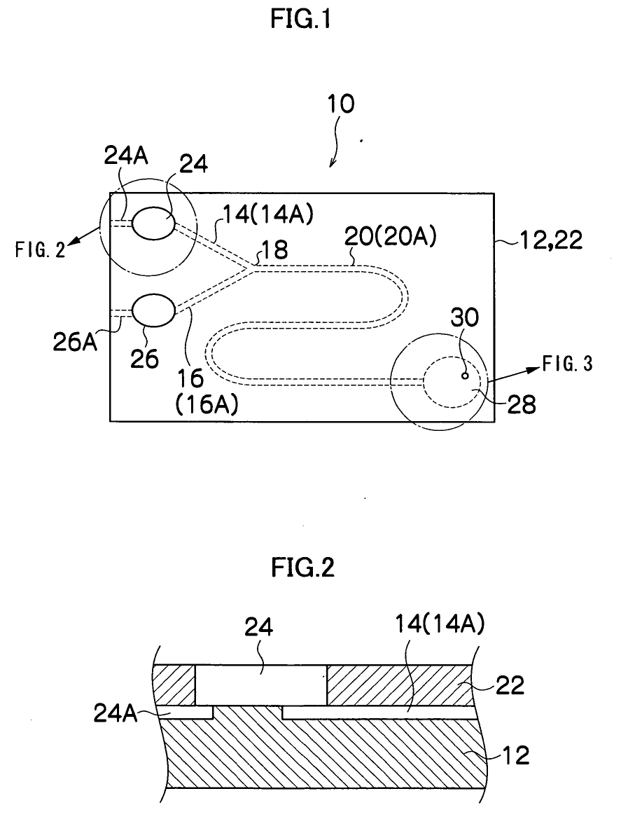

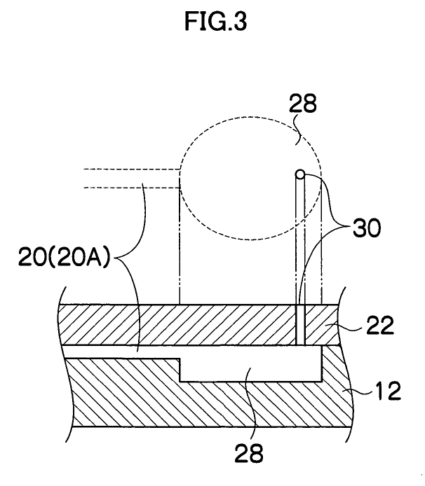

Preferred embodiments (a first embodiment) of a scientific phenomena evaluation apparatus and an educational tool for scientific experiments according to the invention and of a manufacturing method of the evaluation apparatus will be described in detail below with reference to the drawings. FIG. 1 is a plan view to explain the construction of an educational tool for scientific experiments 10 that is a scientific phenomena evaluation apparatus according to the present invention. FIGS. 2 and 3 are a partially enlarged section and the like of FIG. 1, FIG. 2 shows a first liquid reservoir 24 (within the dotted line up left in FIG. 1), and FIG. 3 shows a third liquid reservoir 28 (within the dotted line down right in FIG. 1).

That is, the educational tool for scientific experiments 10 is constituted by a base plate 12 on a plate-like surface of which there are formed long grooves (14, 16 and 20), each having a cross-sectional area of not more than 1 mm², a cover plate 22 that is disposed on the surface of the base plate 12 in close contact therewith and forms fine flow passages (14A, 16A and 20A) on the base plate 12 by covering the long grooves.

The fine flow passages that are formed by the long grooves (14, 16 and 20) are constituted by a first flow passage 14A and a second flow passage 16A having almost the same length, which join in at a meeting point 18, and a third flow passage 20A that joints the first flow passage 14A and the second flow passage 16A at the meeting point 18.

The other end of the first flow passage 14A is in communication with a first liquid reservoir 24, which is a cylindrical hollow part formed on the cover plate 22. The other end of the second flow passage 16A is in communication with a second liquid reservoir 26, which is a cylindrical hollow part formed on the cover plate 22. The other end of the third flow passage 20A is in communication with a third liquid reservoir 28, which is a cylindrical hollow part formed on the base plate 12.

Furthermore, in the base plate 12, there are formed a long groove 24A that permits communication between a first liquid reservoir 24 and outside air and a long groove 26A that permits communication between a second liquid reservoir 26 and outside air. The long grooves 24A, 26A constitute part of the liquid delivering device, which will be described later.

In a portion of the cover plate 22 that faces the third liquid reservoir 28, there is formed a through hole 30 that permits communication between the third liquid reservoir 28 and outside air.

It is preferred that the volume of the first liquid reservoir 24, the second liquid reservoir 26 and the third liquid reservoir 28 be each 5 to 5000 mm³. By ensuring this volume, the control of various phenomena occurring in the microchannels can be easily performed.

Although the two-dimensional size of the base plate 12 and cover plate 22 is not especially limited, from the nature of the educational tool 10 for scientific experiments that is used at school, it is possible to use portable sizes, for example, 80×50 mm. Also, the thickness of the base plate 12 and cover plate 22 is not especially limited. However, from the standpoint of strength, cost efficiency, etc., it is possible to adopt 5 mm or so, for example, for both.

Materials for the base plate 12 are not especially limited. However, from the standpoint of facilitating the manufacturing methods that will be described later, resins, more concretely, polydimethylsulfoxide (PDMS), polymethyl methacrylate (PMMA), polyvinyl chloride (PVC), ultraviolet curing resin, polycarbonate (PC), etc. can be advantageously used.

The cross-sectional area of the long grooves (14, 16 and 20) formed on the surface of the base plate 12 is preferably not more than 1 mm²as stated earlier, more preferably 0.0025 to 0.64 mm²and most preferably 0.01 to 0.25 mm². The cross-sectional shape of the long grooves (14, 16 and 20) is not especially limited and various shapes such as rectangle (square, oblong), trapezoid, V-shape and semicircle can be adopted. However, from the standpoint of facilitating the manufacturing methods that will be described later, the rectangle (square, oblong) is preferable.

Materials for the cover plate 22 are not especially limited. However, transparent materials are preferable to ensure that the scientific phenomena in the flow passages can be recognized by the visual sense. As such materials, it is possible to adopt various kinds of resin plates, more concretely, polydimethylsulfoxide (PDMS), polymethyl methacrylate (PMMA), polyvinyl chloride (PVC), ultraviolet curing resin, polycarbonate (PC), etc., various kinds of resin films, more concretely, polyethylene terephthalate (PET), polyethylene naphthalate (PEN), triacethyl cellulose (TAC), etc., and various kinds of glasses (soda-lime glass, borosilicate glass, etc.).

In general, this cover plate 22 is formed from a flat plate the front and rear surfaces of which are flat. However, it is also possible to form the front surface that corresponds to the fine flow passages (14A, 16A and 20A) in a convex shape so as to permit observation in an enlarged condition.

Incidentally, it is also possible to adopt a construction in which the cover plate 22 is opaque and the base plate 12 is transparent.

It is preferred that for the front surface (the surface on which the long grooves are formed) of the base plate 12 and the rear surface (the surface that comes into close contact with the base plate 12) of the cover plate 22, sufficient flatness be ensured for the formation of the flow passages (14A, 16A and 20A) and from the standpoint of prevention of liquid leakage etc.

Next, how to form the base plate 12 will be described. First, a reverse template on the surface of which the reverse shapes of the long grooves (14, 16 and 20) and long grooves 24A, 26A (part of the liquid delivering device) of the base plate 12 are formed is prepared. It is necessary that on the surface of this reverse template, the revere shape of the third liquid reservoir be further formed beforehand. As a manufacturing method of this reverse template, it is possible to adopt various kinds of publicly known micromachining processes, such as machine-working by use of a machining center and the like, electrical discharge machining, ultrasonic machining, photoetching and microdrilling.

Subsequently, a release agent is applied to the surface of the reverse template. An appropriate release agent can be adopted according to the kind of a resin material that becomes the base plate 12, working conditions (temperature etc.) and the like.

Subsequently, a resin material is applied to the surface of the reverse template and the resin material is caused to cure. When the resin material is, for example, an ultraviolet curing resin, the resin material after application is caused to cure by irradiation with ultraviolet rays. When the resin material is, for example, a thermosetting resin such as polyvinyl chloride (PVC), the resin material is applied to the surface of the reverse template 40 and hot printing is performed by use of a hot press machine.

And the resin material after curing is stripped from the reverse template.

By adopting such a method, it is possible to from the long grooves with high accuracy and at low cost and the evaluation apparatus can be made at low cost.

Next, how to use the educational tool for scientific experiments 10 according to the invention will be described below. As the educational tool for scientific experiments 10, it is necessary to supply the following members 1) to 12) below as a set:

1) Reverse template

2) Resin material for the base plate 12

3) Pattern form for forming the base plate 12

(Used as a pattern form when resin is poured during the formation of the base plate 12.)

4) Cover plate 22

5) Dropper for sample liquid

(Used to supply a necessary sample liquid (reagent) to the first liquid reservoir 24 and the second liquid reservoir 26 according to the test purpose. A dropper for exclusive use may be used for each chemical agent or one dropper may be used for all chemical agents after cleaning.)

6) Tape for sealing the sample liquid inlet and outlet

(Provides covers for the first liquid reservoir 24 and the second liquid reservoir 26 that are holes for supplying a sample liquid. Used to cover the first liquid reservoir 24 and the second liquid reservoir 26 after the supply of a sample liquid to the reservoirs 24, 26 by a pipette. Can also be used as the cover for the third liquid reservoir 28.)

7) Needle

(Used to make a hole in the tape as required when a sample liquid is supplied or recovered, in order to put air into the first liquid reservoir 24 and the second liquid reservoir 26 in an amount corresponding to a change in volume while the liquid is supplied or received.)

8) Casing

(This casing is mounted when the experiment set is assembled, in order to prevent liquid leakage from between the cover plate 22 and the base plate 12 and to prevent a breakage of the cover plate 22 and the like. Incidentally, it is possible to incorporate various functions that suit the purpose of an experiment in the casing, for example, the installation of a magnifying glass to facilitate an observation of the flow passage.)

9) Injector as liquid delivering device

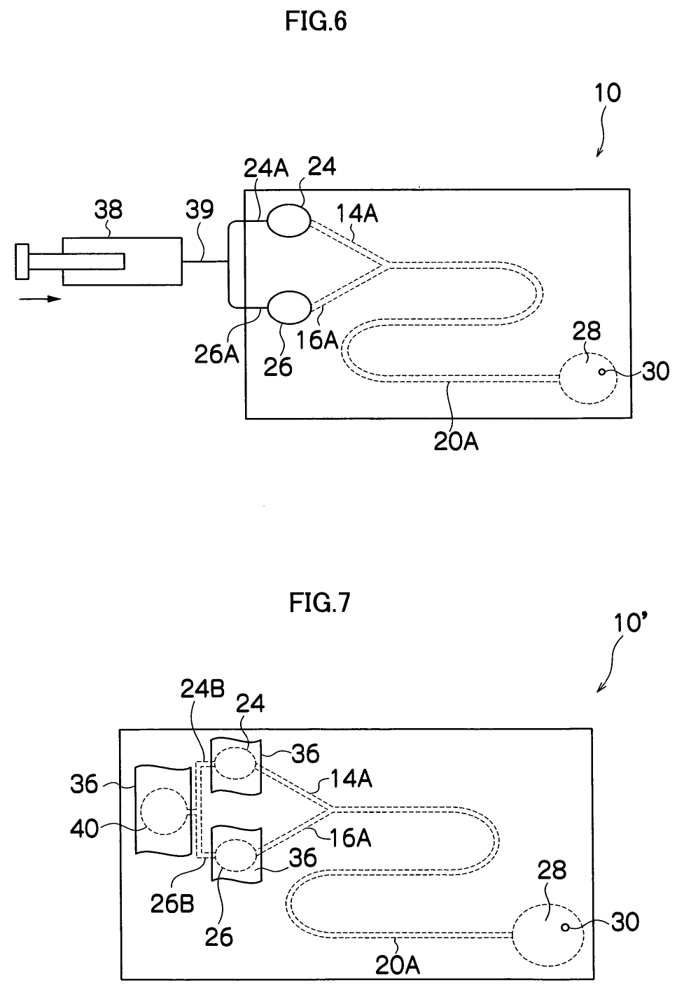

(The interior of the first liquid reservoir 24 and the third second reservoir 26 is pressurized by using a method based on the principle of pump and a liquid in the interior is delivered. As shown in FIG. 6, a tube 39 the leading end of which is bifurcated is attached to the openings of the long grooves 24A, 26A of the base plate 12 and an injector 38 is attached to the base end of this tube 39.)

In this case, when the third liquid reservoir 38 is covered with tape, a small hole is opened in the tape by use of the needle 7) above.

10) Sample liquid (reagent) for test

(Necessary chemical agents that suit the purpose are supplied in reagent containers as test reagents for performing this scientific experiment. As sample liquids, for example, coloring liquids represented by coloring matter or pigments, and transparent liquids such as water can be mentioned.)

11) Practical guide for experiments

(A guide that describes the purpose of experiments conducted by use of this set, descriptions of phenomena, applications and uses, and phenomena that can be learned with this set is attached as required.)

12) Procedural manual for experiment methods

Incidentally, although in this set the base plate 12 is to be made by hand by students, when the hand-making of the base plate 12 is omitted, a complete base plate 12 can be supplied in place of the members 1) to 3) above.

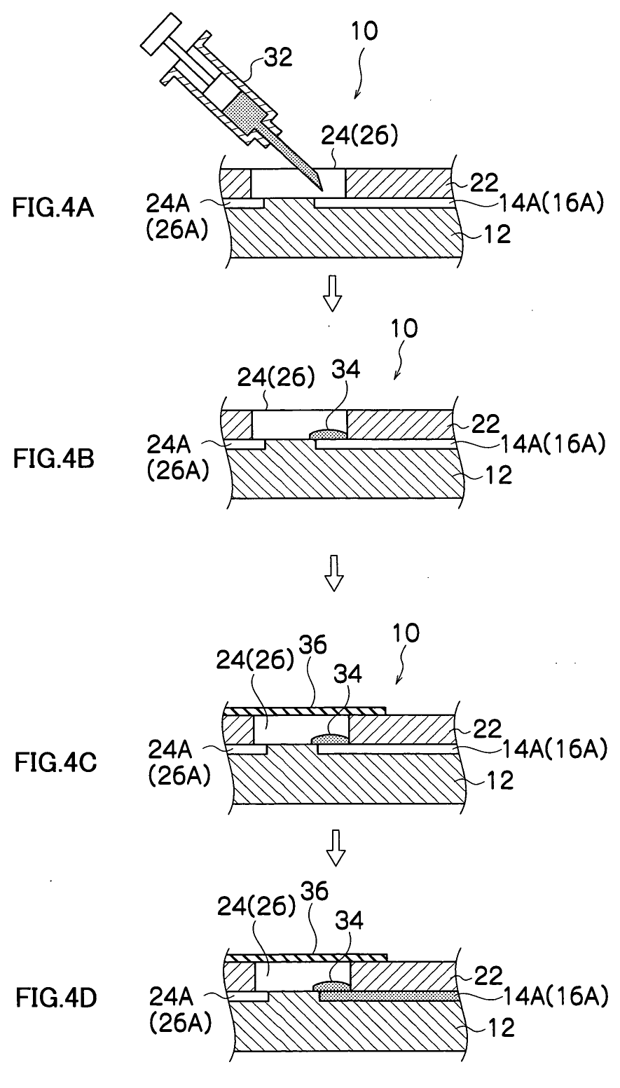

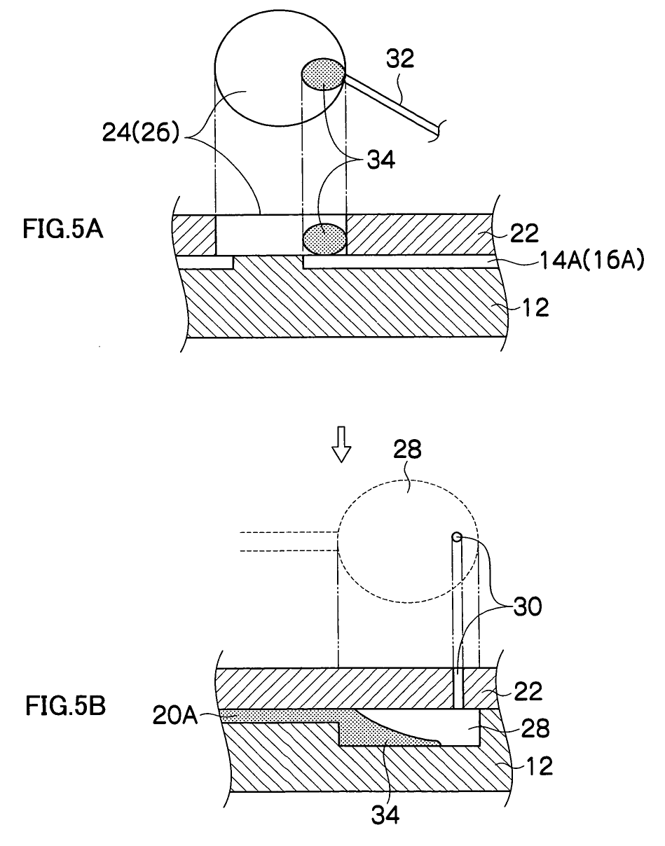

Details of experiments conducted by use of this set will be given below. FIGS. 4A to 4C and FIGS. 5A and 5B are sectional views to explain the procedure for an experiment method. FIGS. 4A to 4D show a time-series procedure in the first liquid reservoir 24 and the second liquid reservoir 26. On the other hand, FIG. 5A shows the condition of the start of an experiment in which a sample liquid is supplied to in the first liquid reservoir 24 and the second liquid reservoir 26, and FIG. 5B shows the state of the finish of the experiment in which the sample liquid has reached the third liquid reservoir 28. FIG. 6 is a plan view of the educational tool for scientific experiments 10 and a drawing to explain the liquid delivering device.

First, as shown in FIG. 6, the tube 39 the leading end of which is bifurcated is attached to the openings of the long grooves 24A, 26A of the base plate 12 and the injector 38 is attached to the base end of this tube 39. The liquid delivering device is formed by the above arrangement.

Subsequently, as shown in FIG. 4A, a prescribed amount of sample liquid 34 is supplied to the first liquid reservoir 24 (or the second liquid reservoir 26) by use of the syringe for sample liquid 32. As shown in FIG. 4B and FIG. 5A, the sample liquid 34 is supplied so as to block a portion that is in communication with the flow passage 14A (or 16A) in the first liquid reservoir 24 (or the second liquid reservoir 26).

Subsequently, as shown in FIG. 4C, the first liquid reservoir 24 (or the second liquid reservoir 26) is covered by use of the tape for sealing sample liquid inlet and outlet 36. In the tape 36, one surface (the bottom surface in the figure) thereof is coated with an adhesive and as a result of this, the first liquid reservoir 24 (or the second liquid reservoir 26) is shut off from outside air.

Subsequently, as indicated by the arrow of FIG. 6, the air in the interior of the injector 38 is fed under pressure into the first liquid reservoir 24 and the second liquid reservoir 26. As a result of this, the sample liquid 34 in the first liquid reservoir 24 (or the second liquid reservoir 26) is fed into the flow passage 14A (or 16A).

As shown in FIG. 5B, the sample liquid 34 reaches the third liquid reservoir 28 by use of the above-described device and the experiment is finished. On that occasion, by delivering sample liquids 34 into the flow passage 14A and the flow passage 16A at the same time from the first liquid reservoir 24 and the second liquid reservoir 26 each, it is possible to observe how the sample liquids 34 joins in at the meeting point 18.

In particular, by changing the color of the sample liquids 34 to be supplied to the first liquid reservoir 24 and the second liquid reservoir 26, it becomes easy to observe how the sample liquids 34 join in at the meeting point 18. For example, a colored sample liquid 34 may be supplied to the first liquid reservoir 24, and a transparent and colorless sample liquid 34 may be supplied to the second liquid reservoir 26.

By observing the flow passage 20A behind the meeting place 18 of the sample liquids 34 that flow in this manner, a person who is carrying out the experiment can recognize how coloring molecules of the coloring matter or pigment diffuse from the side of the colored liquid flowing in the microchannels into the transparent liquid.

Furthermore, by changing not only the color of the sample liquids 34 supplied to the first liquid reservoir 24 and the second liquid reservoir 26, but also their viscosity, how the sample liquids 34 join in at the meeting point 18 can be observed in a different manner.

Incidentally, in order to ensure that these phenomena can be more easily observed, it is also possible to use a reading glass or a magnifying glass. Furthermore, as stated previously, it is also possible to give the function of a magnifying glass (the lens function) to the cover plate 22 in the flow passage 20A.

According to the educational tool for scientific experiments 10 described above, in order to ensure that children can perform scientific experiments in the microscopic world with pleasure, important parts are simplified as far as possible, thereby making it possible to supply this educational tool at low cost, and besides experiments can be conducted with high accuracy.

In particular, when the diffusion phenomena of molecules that provide the basis of chemical reactions are qualitatively observed, in order to improve the experiment accuracy, it is very important that multiple liquids flow in the flow passages be at least under the same conditions. And the educational tool of the present invention can sufficiently meet this requirement. That is, it is possible to conduct experiments with relatively good accuracy by use of a very simple and inexpensive device. Furthermore, because experiments are conducted in the microscopic world, consumption of chemical agents represented by coloring matter or pigments and the like is very small and environmental burdens can be substantially reduced.

Next, the second embodiment of the present invention will be described with reference to FIG. 7. Incidentally, like numerals are given to members that are the same as or similar to those of the above-described first embodiment and the description of these members is omitted.

In the second embodiment, a cylindrical hollow part 40 is formed in the cover plate 22 as a liquid delivering device. It is preferred that the volume of the cylindrical hollow part 40 be 100 to 5000 mm³. In the base plate 12, a long groove 24B that permits communication between the first liquid reservoir 24 and the cylindrical hollow part 40 is formed and, similarly, a long groove 26B that permits communication between the second liquid reservoir 26 and the cylindrical hollow part 40 is formed. The long groove 24B and the long groove 26B have the same cross-sectional area and the same length and join each other before the cylindrical hollow part 40.

Next, how to use an educational tool for scientific experiments 10′ in the second embodiment will be described. In the second embodiment, the set of the educational tool for scientific experiments 10′ may be almost the same as that of the first embodiment described above. Also, details of an experiment conducted by using the set are almost the same as the procedure shown in FIGS. 4A to 4D and FIGS. 5A and 5B. Therefore, descriptions up to FIG. 4C are omitted.

In the condition shown in FIG. 4C, as shown in FIG. 7, the cylindrical hollow part 40 is covered with the sealing tape 36. In the tape 36, one surface (the bottom surface in this figure) thereof is coated with an adhesive and as a result of this, the cylindrical hollow part 40 is shut off from outside air.

Subsequently, the tape 36 on the cylindrical hollow part 40 is warped downward by depressing the tape 36 with the finger tip and the volume of the cylindrical hollow part 40 is reduced. As a result of this, the air in the cylindrical hollow part 40 is fed under pressure and as shown in FIG. 4D, the sample liquid 34 in the interior of the first liquid reservoir 24 (and the second liquid reservoir 26) is fed into the flow passage 14A (and the flow passage 16A).

Incidentally, in a construction similar to that shown in FIG. 7, the liquid delivering device may be based on a method that involves touching the tape 36 on the cylindrical hollow part 40 with the finger tip, thereby to cause cubic expansion to occur in the air in the cylindrical hollow part 40, and feeding this air under pressure to the first liquid reservoir 24 and the second liquid reservoir 26.

When the above-described procedure is followed, as shown in FIG. SB, the sample liquid 34 reaches the third liquid reservoir 28 and the experiment is finished. On that occasion, by delivering the sample liquids 34 into the flow passage 14A and the flow passage 16A at the same time from the first liquid reservoir 24 and the second liquid reservoir 26, it is possible to observe how the sample liquids 34 join in at the meeting point 18.

Although the embodiments of a scientific phenomena evaluation apparatus and an educational tool for scientific experiments according to the present invention and of a manufacturing method of the evaluation apparatus and educational tool have been described above, the invention is not limited to the above-described embodiments and it is possible to adopt various kinds of aspects.

For example, in the above-described embodiments, the description has been given of the example of the educational tool for experiments in which two kinds of sample liquids 34 join in at the meeting point 18 and the phenomenon that coloring molecules of coloring matter or pigments diffuse toward a transparent liquid can be observed. However, the educational tool for scientific experiments of the present invention can also be applied as various educational tools for scientific experiments other than this.

Furthermore, in the above-described embodiments, the first liquid reservoir 24 and the second liquid reservoir 26 are formed on the cover plate 22 and the third liquid reservoir 28 is formed on the base plate 12. However, it is possible to adopt aspects other than this; for example, all liquid reservoirs can be formed on the cover plate 22.

Although in the above-described embodiments, three sets of flow passages and liquid reservoirs are provided, it is possible to adopt a constitution in which four or more sets are provided.

Although two different examples were given as the liquid delivering device in the first and second embodiments, it is also possible to adopt other constructions from which similar effects can be obtained.

Furthermore, although the dropper for sample liquid 32 is used to supply a sample liquid (reagent) to the liquid reservoirs (24, 26, etc.), in place of this it is also possible to use an injector, a microsyringe, etc. having the same function. In general, it is desirable to use an inexpensive dropper as an educational tool for scientific experiments. However, according to the purpose of a test, it may sometimes be desirable to use the above-described injector, microsyringe, etc. having the same function.

1. A scientific phenomena evaluation apparatus, comprising:
a base plate on a plate-like surface of which there are formed a plurality of long grooves each having a cross-sectional area of not more than 1 mm²; and
a cover plate that is disposed on a surface of the base plate in close contact therewith and forms a plurality of fine flow passages on the base plate by covering the long grooves,
wherein an end of each of the plurality of flow passages joins in at one meeting point and the other end of each of the plurality of flow passages is in communication with a liquid reservoir each having a volume of 5 to 5000 mm³;
a liquid delivering device is provided in one or more of the liquid reservoirs; and
scientific phenomena in the flow passages can be visually recognized.

2. A scientific phenomena evaluation apparatus, comprising:
a base plate on a plate-like surface of which there are formed a plurality of long grooves each having a cross-sectional area of not more than 1 mm²; and
a cover plate that is disposed on a surface of the base plate in close contact therewith and forms a plurality of fine flow passages on the base plate by covering the long grooves,
wherein an end of a first flow passage and an end of a second flow passage meet each other at one meeting point, the two flow passages being the above-described flow passages having almost the same length;
the other end of the first flow passage is in communication with a first liquid reservoir having a volume of 5 to 5000 mm³;
the other end of the second flow passage is in communication with a second liquid reservoir having a volume of 5 to 5000 mm³;
an end of a third flow passage, which is one flow passage as described above, is in communication with the meeting point, the other end of the third flow passage being in communication with a third reservoir having a volume of 5 to 5000 mm³;
a liquid delivering device is provided in one or more of the liquid reservoirs; and
scientific phenomena in the flow passages can be visually recognized.

3. The scientific phenomena evaluation apparatus according to claim 1, wherein the base plate and/or the cover plate is transparent.

4. The scientific phenomena evaluation apparatus according to claim 2, wherein the base plate and/or the cover plate is transparent.

5. The scientific phenomena evaluation apparatus according to claim 1, wherein the base plate and/or the cover plate is formed from a resin material.

6. The scientific phenomena evaluation apparatus according to claim 2, wherein the base plate and/or the cover plate is formed from a resin material.

7. The scientific phenomena evaluation apparatus according to claim 3, wherein the base plate and/or the cover plate is formed from a resin material.

8. The scientific phenomena evaluation apparatus according to claim 4, wherein the base plate and/or the cover plate is formed from a resin material.

9. The scientific phenomena evaluation apparatus according to claim 2, wherein the liquid delivering device is a device that pressurizes the interior of the first liquid reservoir and the second liquid reservoir.

10. The scientific phenomena evaluation apparatus according to claim 4, wherein the liquid delivering device is a device that pressurizes the interior of the first liquid reservoir and the second liquid reservoir.

11. The scientific phenomena evaluation apparatus according to claim 6, wherein the liquid delivering device is a device that pressurizes the interior of the first liquid reservoir and the second liquid reservoir.

12. The scientific phenomena evaluation apparatus according to claim 8, wherein the liquid delivering device is a device that pressurizes the interior of the first liquid reservoir and the second liquid reservoir.

13. An educational tool for scientific experiments, wherein the tools is a portable experiment apparatus by the scientific phenomena evaluation apparatus of claim 1.

14. An educational tool for scientific experiments, wherein the tools is a portable experiment apparatus by the scientific phenomena evaluation apparatus of claim 2.

15. An educational tool for scientific experiments, wherein the tools is a portable experiment apparatus by the scientific phenomena evaluation apparatus of claim 7.

16. An educational tool for scientific experiments, wherein the tools is a portable experiment apparatus by the scientific phenomena evaluation apparatus of claim 8.

17. An educational tool for scientific experiments, wherein the tools is a portable experiment apparatus by the scientific phenomena evaluation apparatus of claim 12.

18. A manufacturing method of the scientific phenomena evaluation apparatus of claim 1, comprising the steps of:
applying a resin material to a surface of a reverse-template on which a reverse shape of the long groove of the base plate is formed;
causing the resin material to cure; and
stripping the resin material after curing from the reverse template thereby to form the base plate.

19. A manufacturing method of the scientific phenomena evaluation apparatus of claim 2, comprising the steps of:
applying a resin material to a surface of a reverse template on which a reverse shape of the long groove of the base plate is formed;
causing the resin material to cure; and
stripping the resin material after curing from the reverse template thereby to form the base plate.

20. A manufacturing method of the scientific phenomena evaluation apparatus of claim 7, comprising the steps of:
applying a resin material to a surface of a reverse template on which a reverse shape of the long groove of the base plate is formed;
causing the resin material to cure; and
stripping the resin material after curing from the reverse template thereby to form the base plate.

21. A manufacturing method of the scientific phenomena evaluation apparatus of claim 12, comprising the steps of:
applying a resin material to a surface of a reverse template on which a reverse shape of the long groove of the base plate is formed;
causing the resin material to cure; and
stripping the resin material after curing from the reverse template thereby to form the base plate.

22. A manufacturing method of the educational tool for scientific experiments of claim 13, comprising the steps of:
applying a resin material to a surface of a reverse template on which a reverse shape of the long groove of the base plate is formed;
causing the resin material to cure; and
stripping the resin material after curing from the reverse template thereby to form the base plate.

23. A manufacturing method of the educational tool for scientific experiments of claim 14, comprising the steps of:
applying a resin material to a surface of a reverse template on which a reverse shape of the long groove of the base plate is formed;
causing the resin material to cure; and
stripping the resin material after curing from the reverse template thereby to form the base plate.

24. A manufacturing method of the educational tool for scientific experiments of claim 15, comprising the steps of:
applying a resin material to a surface of a reverse template on which a reverse shape of the long groove of the base plate is formed;
causing the resin material to cure; and
stripping the resin material after curing from the reverse template thereby to form the base plate.

25. A manufacturing method of the educational tool for scientific experiments of claim 17, comprising the steps of:
applying a resin material to a surface of a reverse template on which a reverse shape of the long groove of the base plate is formed;
causing the resin material to cure; and
stripping the resin material after curing from the reverse template thereby to form the base plate.
